(19) United States
(12) Patent Application Publication
(10) Pub. No.: US 2006/0123083 A1
(43) Pub. Date: Jun. 8, 2006

(54) Adaptive spam message detector

(75) Inventors: Cyril Goutte, Le Versoud (FR); Pierre Isabelle, Biviers (FR); Eric Gaussier, Eybens (FR); Stephen Kruger, Grenoble (FR)

Correspondence Address: Xerox Corporation;Patent Documentation Center, Xerox Sq. 20th Floor, 100 Clinton Avenue South, Rochester, NY, 14644, US

(73) Assignee: Xerox Corporation

(21) Appl. No.: 11/002,179

(22) Filed: Dec. 3, 2004

(51) Int. Cl. G06F 15/16

(52) U.S. Cl. 709/206

(57) ABSTRACT

Electronic content is filtered to identify spam using image and linguistic processing. A plurality of information type gatherers assimilate and output different message attributes relating to message content associated with an information type. A categorizer may have a plurality of decision makers for providing as output a message class for classifying the message data. A history processor records the message attributes and the class decision as part of the prior history information and/or modifies the prior history information to reflect changes to fixed data and/or probability data. A categorizer coalescer assesses the message class output by the set of decision makers together with optional user input for producing a class decision identifying whether the message data is spam.

### BACKGROUND AND SUMMARY

The following relates generally to methods, and apparatus therefor, for filtering and routing unsolicited electronic message content.

Given the availability and prevalence of various technologies for transmitting electronic message content, consumers and businesses are receiving a flood of unsolicited electronic messages. These messages may be in the form of email, SMS, instant messaging, voice mail, and facsimiles. As the cost of electronic transmission is nominal and email addresses and facsimile numbers relatively easy to accumulate (for example, by randomly attempting or identifying published email addresses or phone numbers), consumers and businesses become the target of unsolicited broadcasts of advertising by, for example, direct marketers promoting products or services. Such unsolicited electronic transmissions sent against the knowledge or interest of the recipient is known as “spam”.

There exist different methods for detecting whether an electronic message such as an email or a facsimile is spam. For example, the following U.S. Patent Nos. describe systems that may be used for filtering facsimile messages: U.S. Pat. Nos. 5,168,376; 5,220,599; 5,274,467; 5,293,253; 5,307,178; 5,349,447; 4,386,303; 5,508,819; 4,963,340; and 6,239,881. In addition, the following U.S. Patent Nos. describe systems that may be used for filtering email messages: U.S. Pat. Nos. 6,161,130; 6,701,347; 6,654,787; 6,421,709; 6,330,590; and 6,324,569.

Generally, these existing systems rely on either feature-based methods or content based methods. Features based methods filter based on some characteristic(s) of the incoming email or facsimile. These characteristics are either obtained from the transmission protocol or extracted from the message itself. Once the characteristics are obtained, the incoming message may be filtered on the basis of a whitelist (i.e., acceptable sender list or a non-spammer list), a blacklist (i.e., unacceptable sender list or spammer list) or a combination of both. Content based methods may be pattern matching techniques, or alternatively may involve categorization of message content. In addition, these methods may require some user-intervention, which may consist of letting the user finally decide whether or not a message is spam.

However, notwithstanding these different existing methods, the receipt and administration of spam continues to result in economic costs to individuals, consumers, government agencies, and business that receive it. The economic costs include loss of productivity (e.g., wasted attention and time of individuals), loss of consumables (such as paper when facsimile messages are printed), and loss of computational resources (such as lost bandwidth and storage). Accordingly, it is desirable to provide an improved method, apparatus, and article of manufacture for detecting and routing spam messages based on their content.

In accordance with the various embodiments described herein, there is described a system, and method and article of manufacture therefor, for filtering electronic content for identifying spam in message data. The system includes: a content extractor for identifying and selecting message content in the message data; a content analyzer having a plurality of information type gatherers for assimilating and outputting different message attributes relating to the message content associated with an information type; a categorizer having a plurality of decision makers for receiving as input the message attributes and prior history information and providing as output a message class for classifying the message data; a history processor receiving as input (i) the class decision, (ii) the message class for each of the plurality of decision makers, (iii) message attributes of the plurality of information types, and (iv) prior history information, for (a) recording the message attributes and the class decision as part of the prior history information and/or (b) modifying the prior history information to reflect changes to fixed data or probability data; and a categorizer coalescer for assessing the message class output by the set of decision makers together with optional user input for producing a class decision identifying whether the message data is spam.

### BRIEF DESCRIPTION OF THE DRAWINGS

These and other aspects of the disclosure will become apparent from the following description read in conjunction with the accompanying drawings wherein the same reference numerals have been applied to like parts and in which:

FIG. 1 illustrates one embodiment of a system for identifying spam in message data;

FIG. 2 illustrates a flow diagram setting forth one example operation sequence of the system shown in FIG. 1;

FIG. 3 illustrates one embodiment for adapting whitelists and/or blacklists using history information;

FIG. 4 is a flow diagram for dynamically updating a soft blacklist;

FIG. 5 is a flow diagram for implementing a hybrid whitelist/blacklist mechanism that combines history information and user feedback; and

FIG. 6 illustrates an alternate embodiment in which the system for identifying spam in message data shown in FIG. 1 is embedded in a multifunctional device.

### DETAILED DESCRIPTION

The table that follows set forth definitions of terminology used throughout the specification, including the claims.

| Term | Definition |
|---|---|
| FTP | File Transfer Protocol |
| HTML | HyperText Markup Language |
| HTTP | HyperText Transport Protocol |
| OCR | Optical Character Recognition |
| PDF | Portable Document Format |
| SMS | Short Message Service |
| SVM | Support Vector Machines |
| URL | Uniform Resource Locator |

A. System Operation

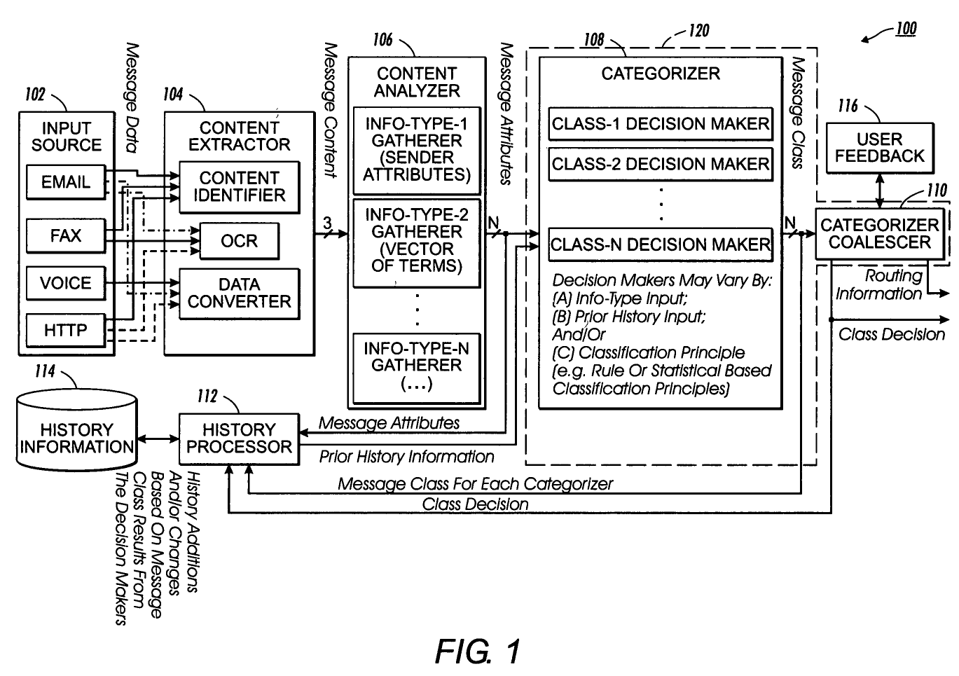

FIG. 1 illustrates one embodiment of a system 100 for identifying spam in message data. Optionally, once spam is identified in message data, the message may be filtered to remove spam and/or routed if spam is detected, as specified by output from categorizer coalescer 110 as, for example, it determines automatically and/or with the aid of user feedback 116. Message data may be received from one or more input sources 102. The message data from the input message source 102 may be specified in one or more (or a combination of) forms (i.e., protocols), such as, FTP, HTTP, email, facsimile, SMS, instant messaging. In addition, the message content may take on any number of formats such as text data, graphics data, image data, audio data, and video data.

The system 100 includes a content extractor 104 and a content analyzer 106. The content extractor 104 extracts different message content in the message data received from the input sources 102 for input to the content analyzer 106. In one embodiment, a content identifier, OCR (and OCR correction), and a converter form part of content extractor 104. In another embodiment, only the content identifier and/or content converter form part of the content extractor 104. The form of the message data received by the different components of the content extractor 104 from the input source 102 may be one that is possible to be input directly to content analyzer 106, or it may be in a form that requires pre-processing by the content extractor 104.

For example, in the event the message data is or contains image data (i.e., a sequence of images), the message data is first OCRed (together with possibly OCR correction, for example, to correct spelling using a language model and/or improve word recognition rate) to identify textual content therein (e.g., facsimile message data or images embedded in emails or images embedded in HTTP (e.g., from web browsers) that may be in one or more formats (GIF, TIFF, JPEG, etc.)). This enables the detection of textual spam hidden in image content. Alternatively, the message data may require converting to text depending on the format of the message data and/or the documents to which message data may be linked. Converters to text from different file formats (e.g., PDF, PostScript, MS Office formats (.doc, .rtf, .ppt, xIs), HTML, and compressed (zipped) versions of these files) exist. In addition, in the event the message data is voice data, it may require conversion using known audio-to-text converters (e.g., audio data that may be embedded in, attached to, or linked to, email message data or HTTP advertisements).

The system 100 also includes a content analyzer 106 that is made up of a plurality of information type gatherers for assimilating and outputting different message attributes that relate to the message content associated with the information type assigned by the content extractor 104. The message content output by the content extractor 104 may be directed to one or more information-type (i.e., “info-type”) gatherers of the content analyzer 106. In one embodiment, one info-type gatherer identifies sender attributes in the message data, and a second info-type gatherer transforms message data to a vector of terms identifying, for example, a term's frequency of use in the message data and/or other terms used in context (i.e., neighboring terms). Once each info-type gatherer finishes processing the message content, its output in the form of message attributes is input to categorizer 108.

In this or alternate embodiments, additional combinations of info-type gatherers are adapted to process different attributes or features of text and/or image content depending on the input source 102. For example, in one embodiment an info-type gatherer is adapted to transform OCRed facsimile message data to a vector of terms with one attribute per-feature by: (i) tokenizing (and optionally normalizing) words in OCRed facsimile message data; (ii) optionally, performing morphological analysis to the surface form of a word (i.e., as it appears in the OCRed facsimile message) and return its lemma (i.e., the normalized form of a word that can be found in a dictionary), together with a list of one or more morphological features (e.g., gender, number, tense, mood, person, etc.) and part-of-speech (POS); (iii) counting words or lemmas; (iv) associating each word or lemma with a feature; and (v) optionally, weighing feature counts using, for example, inverse document frequency.

Further, in this or other embodiments, combinations of info-type gatherers that are adapted to gather sender attributes extract different features from message content, such as, sender attributes. In addition to all the words recognized through OCR, a number of features may be extracted from the transmission protocol of a message, such as: sender information (e.g., email address, FaxID or Calling Station Identifier, CallerID, IP or HTTP address, and/or fax number), date and time of transmission and reception.

The categorizer 108 has a set of decision makers that receive as input the message attributes from the content analyzer 106 and prior history information from history processor 112. Generally, each decision maker may work on a different data type and/or rely on different decision making principles (e.g., rule based or statistical based). Each decision maker of the categorizer 108, provides as output a message class for classifying the message data that is input to categorizer coalescer 110. Further, each decision maker operates independently to categorize the message attributes output by content analyzer 106 using one or more message attributes and, possibly, prior history information. For example, one decision maker (or categorizer) may take as input sender attributes and make use of a whitelist and/or blacklist forming part of history data 114 to evaluate sender attributes and assess whether the sender of the message data is spam. Another example of a decision maker takes as input a vector of terms and bases its categorization decision on statistical analysis of the vector of terms.

Various embodiments for statistically categorizing the message attributes are described in more detail below. Advantageously, these statistical approaches to message data categorization may be adapted to rely on rules, such as, a rule that accounts for differences between a CallerlD and a number sent during the fax protocol (usually displayed on the top line of each fax page), or a rule that accounts for receiving a fax at unusual hours of the day (i.e., outside the normal working day).

More generally, each decision maker is a class decision maker, where the “class” of the decision maker may vary depending on: (a) the output from an info-type gatherer received from the content analyzer 106 that it uses; (b) history information 114 received from the history processor 112 that it uses; and/or (c) classification principles that it bases its decision on (i.e., a decision function that may be adaptive, e.g., rule or statistical based classification principles, or a combination thereof). An example of a rule-based classification principle is a classifier that bases its decision on a white-list and/or a black-list, whereas a Naïve Bayes categorizers is an example of a statistical based classifier.

The message class output by the set of decision makers forming part of the categorizer 108, is assessed by the categorizer coalescer 110 together with user input 116, which may be optional, to produce an overall class decision determining whether the message data is spam by, for example, using one or more or a combination of: a voting scheme, using a weighted averaging scheme (e.g., based on a decision maker's confidence), boosting (i.e., one or more categorizers receives the output of other categorizer(s) as input to define a more accurate classification rule by combining one or more weaker classification rules). In addition, the categorizer coalescer 110 offers routing functions, which may vary depending on the overall class decision and, possibly, the certainty of that decision. For example, message data determined to be spam with a high degree of certainty may be automatically deleted while message data with less than a high degree of certainty may be placed in temporary storage for user review.

Further, the system 100 includes a history processor 112 which stores, modifies, and accesses history data 114 stored in memory of system 100. The history processor 112 evaluates the independently produced message class output by each decision maker in the categorizer 108. That is, the history processor 112 allows the system 100 to adapt its decision function using the history of message data originating from the same sender. This means that a message received from a sender that has previously sent several borderline messages may eventually be flagged as spam by one of the adaptive decision functions described below.

More specifically, the history processor 112 receives as input (i) the overall class decision from the categorizer coalescer 110, (ii) the message class for each of the plurality of decision makers of the categorizer 108, (iii) the message attributes for the plurality of information types output by the content analyzer 106 and (iv) the history information 114. With the inputs (i)-(iv), the history processor (a) records the message attributes and the class decision(s) as part of the prior history information 114 and/or (b) modifies the prior history information 114 to reflect changes to fixed data or probability data.

Depending on the certainty of each categorizer's decision, the history processor 112 assesses the totality of the different message classification results and based on the results modifies history data to reflect changed circumstances (e.g., moving a sender from a whitelist to a blacklist). For example, if a majority of the decision makers of the categorizer 108 indicate that message content is not spam while the sender information indicates the message data is spam because the sender is on the blacklist, the history processor 112 adaptively manages the content of the whitelist and blacklist by updating the history data to remove the sender from the blacklist and, possibly in addition, add the sender to the whitelist.

The table below illustrates an example of history information 114 recorded in one embodiment of the system 100 shown in FIG. 1. The form of history information may be data and/or a probability value. Whether the history information is updated will depend on whether a current decision is consistent with a set of one or more prior decisions.

| HISTORY | |
|---|---|
| INFORMATION | DESCRIPTION |
| Whitelist | List of approved senders of message data (i.e., |
| | trusted sender, e.g., identified by one or more |
| | of email address, phone number, IP address, |
| | HTTP address). |
| Blacklist | List of disapproved senders of message data (i.e., |
| | non-trusted sender, e.g., identified by one or |
| | more of email address, phone number, IP address, |
| | HTTP address). |
| Sender | Records of prior decisions related to senders and |
| Attributes | sender attributes (e.g., time message |
| | sent/received, length of message, type of message, |
| | language of message, where the message was sent |
| | from, etc.). |
| Language | Types of words, arrangement of words, unrecognized |
| Attributes | words (i.e., not in dictionary), frequency of word |
| | use, etc., each of which may or may not be |
| | associated with a sender. |
| Image | Objects or words identified in content of images, |
| Attributes | similarity to known images, etc., each of which |
| | may or may not be associated with a sender. |
| Cross-link | Links identifying relationships between attribute |
| Data | data. |
| Probability | Probability data associated with attribute or |
| Data | cross-linked data. |

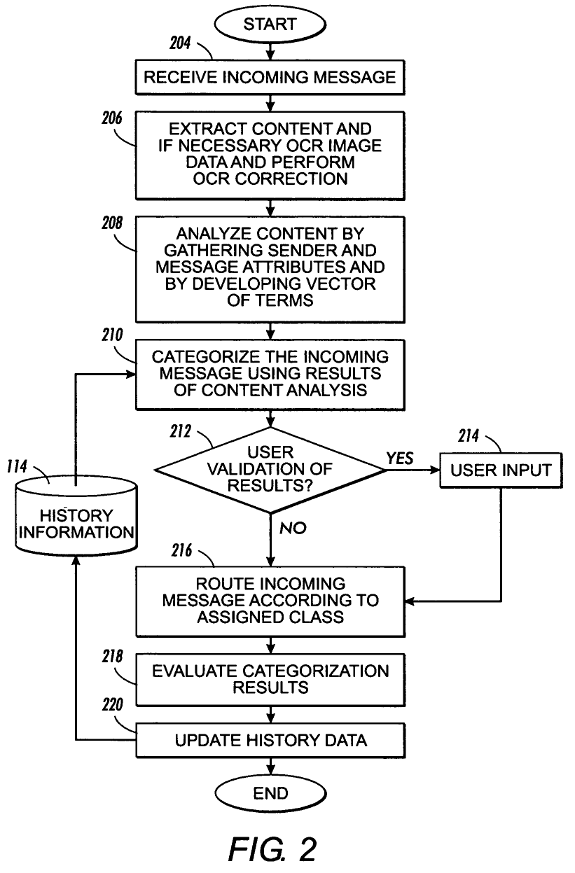

FIG. 2 illustrates a flow diagram setting forth one example operation sequence of the system 100 shown in FIG. 1. Before following the operation sequence shown in FIG. 2, the system 100 is initialized. As part of initialization, the feature set(s) are decided upon and the decision maker(s) are trained using features extracted from a training corpus. Once initialized, an incoming message is received (at 204) from an input source 102 and content is extracted therefrom by the content extractor 104 (at 206). The extracted content is OCRed if image content is identified in (or found to be linked thereto) to produce textual content. The OCRed textual content is optionally corrected to correct spelling using a language model and/or improve word recognition rate.

The message content extracted (at 206) is analyzed (at 208) by, for example, gathering sender and message attributes and/or by developing one or more vectors of terms. The incoming message is categorized (at 210) using one or more of the results of the content analysis (at 208) together with history information 114. If the user specifies that the results are to be validated (at 212), then user input is sought (at 214). Subsequently, the incoming message is routed (at 216) according to how the incoming message is categorized (at 210) and validated (if performed, at 214), and the categorization results (computed at 210) are evaluated (at 218) in view of the existing history data.

Depending on the results of the evaluation (at 218), history information 114 is updated (at 220) by either modifying existing history information or adding new history information. Advantageously, future incoming messages categorized (at 210) make use of prior history data that adapts in time as the content in the incoming messages changes. For example, the use of history information 114 enables dynamic management of whitelists and blacklists through adaptive unsupervised learning by cross-referencing the results of different decision makers in the categorizer 108 (e.g., by moving, adding or removing a sender from a whitelist to/or a blacklist based on content analysis).

B. Embodiments Of Statistical Categorizers

Embodiments of statistical categorization performed by one or more decision maker forming categorizer 108 are described in this section. In these embodiments, statistical categorization methods are used in the following context: from a training set of annotated documents (i.e., messages) {(d¹,z¹),(d²,z²), . . . (d^{N},z^{N})} such that for all i, document dⁱ has label zⁱ (where e.g., zⁱε{0,1} with 1 signifying spam and 0 signifying legitimate messages), a discriminant function f(d) is learned, such that f(d)>0 if and only if d is spam. This decision rule may be interpreted using at least the three statistical categorization models described below. These models differ in the parameters they use, the estimation procedure for these parameters, as well as, the manner in which the decision function is implemented.

B.1 Categorization Using Naïve Bayes

In one embodiment, categorization decisions are performed by a decision maker of the categorizer 108 using a Naïve Bayes formulation, as disclosed for example by Sahami et al., in a publication entitled “A Bayesian approach to filtering spam e-mail, Learning for Text Categorization”, published in Papers from the 1998 AAAI Workshop, which is incorporated herein by reference. In this statistical categorization method, the parameters of the model are the conditional probabilities of features w given the class c, P(w|c), and the class priors P(c). Both probabilities are estimated using the empirical frequencies measured on a training set. The probability of a document d containing the sequence of words (w₁,w₂, . . . w_{L}) is then

$$P ( d \vert c ) = {\prod }_{i} P ( {w}_{i} \vert c ) ,$$

and the assignment probability is P(c|d)∞P(d|c)P(c). The decision rule combines these probabilities as f(d)=log P(c=1|d)−log P(c=0|d).

B.2 Categorization Using Probabilistic Latent Analysis

In another embodiment, categorization decisions are performed by a decision maker of the categorizer 108 using probabilistic latent analysis, as disclosed for example by Gaussier et al. in a publication entitled “A Hierarchical Model For Clustering And Categorizing Documents”, published in F. Crestani, M. Girolami and C. J . van Rijsbergen (eds), Advances in Information Retrieval—Proceedings of the 24^{th} BCS-IRSG European Colloquium on IR Research, Lecture Notes in Computer Science 2291, Springer, pp. 229-247, 2002, which is incorporated herein by reference. The parameters of the model are the same as for Naïve Bayes, plus the conditional probabilities of documents given the class, P(d|c), and they are estimated using the iterative Expectation Maximization (EM) procedure. At categorization time, the conditional probability of a new document P(d^{new}|c) is again estimated using EM, and the remaining part of the process (posterior and decision rule) is the same as Naïve Bayes described above.

B.3 Categorization Using Support Vector Machines

In another embodiment, categorization decisions are performed by a decision maker of the categorizer 108 using Support Vector Machines (SVM). It will be appreciated by those skilled in the art that while probabilistic models are well suited to multi-class problems (e.g., general message routing) but do not allow very flexible feature weighting schemes, SVM allow any weighting scheme but are restricted to binary classification in their basic implementation.

More specifically, SVM implement a binary classification rule expressed as a linear combination of similarity measures between a new document (i.e., message data) d^{new} and a number of reference examples called “support vectors”. The parameters are the similarity measure (i.e., kernel) K(dⁱ,dⁱ), the set of support vectors and their respective weights aⁱ (an example, of the use of SVM is disclosed by Drucker et al., in a publication entitled “Support Vector Machines for Spam Categorization”, IEEE Trans. on Neural Networks, 10:5(1048-1054), 1999, which is incorporated herein by reference). The weights aⁱ are obtained by solving a constrained quadratic programming problem, and the similarity measure is selected using cross-validation from a fixed set including polynomial and RBF (Radial Basis Function) kernels. The decision rule is given by

$$f ( d ) = {\sum }_{i} {α}^{i} K ( d , {d}^{i} ) ,$$

with aⁱ≠0 for support vectors only.

C. Soft Whitelists/Blacklists

Generally, rule based decision making using fixed whitelists and blacklists are not sufficient on their own as they yield binary (i.e., categorical) decisions based on a rigid assumption that a sender is either legitimate or not, independent of the content of a message. That is, the use of whitelists tend to be too closed (i.e., they tend to identify too many messages as spam) while the use of blacklists tend to be too open (i.e., they tend to identify too few messages as spam). Further, both whitelists and blacklists tend to be too categorical (e.g., messages from a blacklisted sender will be rejected as spam, regardless of its content). Various embodiments set forth in this section advantageously provide operating embodiments for the history processor 112 shown in FIG. 1 that adaptively maintain the contents of probabilistic, or “soft” whitelist(s) and blacklist(s) stored as part of the history information 114 and used by one or more decision makers forming part of the categorizer 108.

C.1 Adaptation Using User Feedback

In a first embodiment, whitelists and/or blacklists stored in the history information 114 are updated using user feedback 116. In this embodiment, senders addresses (e.g., numbers or email or IP or HTTP addresses) of messages that are determined by categorizer coalescer 110 and acknowledged from user feedback 116 to be spam are added to the blacklist (and removed from the corresponding whitelist) information associated with that sender (e.g., phone number (determined by callerID or facsimile header) or email or IP or HTTP address), thereby minimizing future spam received from that sender. This may be implemented either automatically (e.g., implicitly, if the status of a message identified as spam is not changed after some period of time), or only after receiving user feedback confirming that the filtered message is spam. This embodiment provides a dynamic method for filtering senders of spam who regularly change their identifying information (e.g., phone number or email or IP or HTTP address) to avoid being blacklisted.

The same adaptive process is possible for updating a whitelist. Once the categorizer coalescer 110 has flagged an incoming message as legitimate, the associated sender information (e.g., phone number or email or IP or HTTP address) may be automatically inserted in the whitelist and/or removed from a corresponding blacklist by the history processor 112. Such changes to the whitelist and blacklist forming part of the history information 114 may also be conditioned on explicit or implicit user feedback 116, as for the blacklist (e.g., the user could explicitly confirm the legitimate status, or implicitly by not changing the determined status of a message after a period of time).

C.2 Adaptation Using History Information

In a second embodiment, the history processor 112 adapts the whitelist and blacklist (or simply blacklist or simply whitelist) stored in history information 114 by leveraging history information concerning the various message attributes (e.g., sender information, content information, etc.) received from the content analyzer 106 and the one or more decisions received from categorizer 108 (and possibly the overall decision if there is more than one decision maker that is received from the categorizer coalescer 110). That is, the history processor 112 keeps track of sender information in order to combine the evidence obtained from the incoming message with the available sender history. Using this history, the system 100 is adapted to leverage sender statistical information to take into account a favorable (or unfavorable) bias if the sender has already sent several messages that were judged (i.e., by its class decisions) legitimate (or not legitimate) with a high confidence or an opposite bias if the sender has previously sent messages that were only borderline legitimate.

More specifically in this second embodiment, the history processor 112 dynamically manages a probabilistic (or “soft”) whitelist/blacklist in the history information 114 rather than a binary (or “categorical”) whitelist/blacklist. That is, instead of a clear-cut evaluation that a sender x is or is not included in a blacklist (i.e., either xε blacklist or xε blacklist), each sender x is evaluated using a probability P(blacklist|x) (i.e., probability that the sender x is on the blacklist) or equivalently an original belief P(spam|x) (i.e., the original belief or knowledge that the sender x transmits spam).

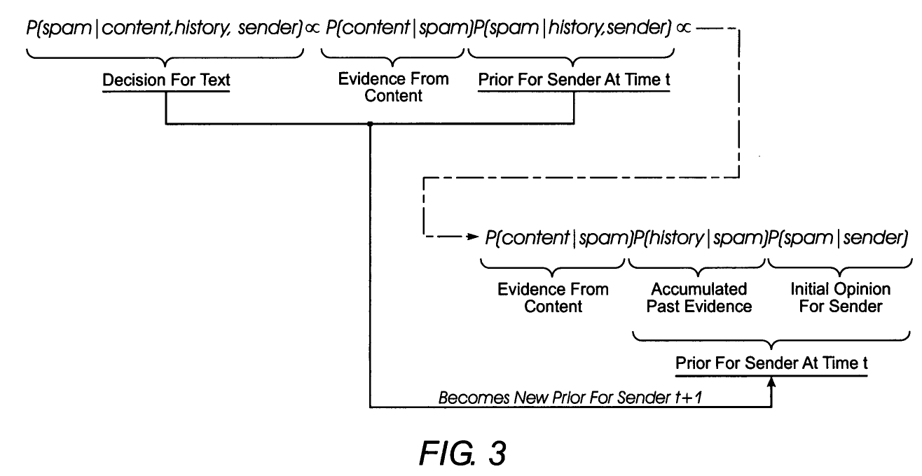

For example, FIG. 3 illustrates an embodiment for using and updating a soft blacklist. In FIG. 3, the symbol “∝” signifies proportionality, “content” is content such as text identified in a current message, “sender” identifies the sender of the current message, and “history” identifies information concerning the sender that is obtained from previously observed content and sender information. As shown in FIG. 3, determining whether a message from a sender is spam is based on: (1) evidence from the message content; (2) accumulated evidence from previous content received from the same sender; and (3) initial opinion (or bias) on the sender, before any content is received.

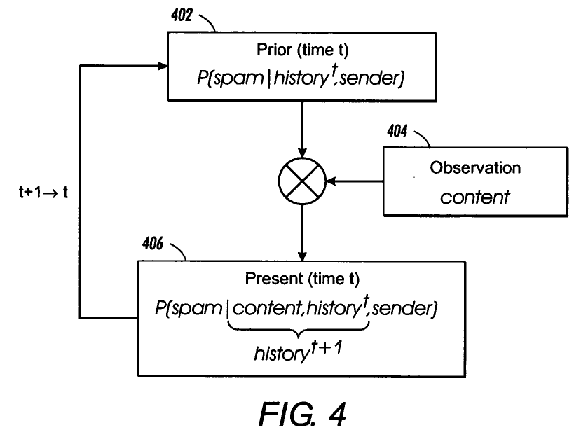

Further as shown in FIG. 3, the probability decision that a message is spam P(spam|content,history,sender) may be proportionally represented by the two factors P(content|spam) (i.e., evidence from the data or message) and P(spam|history,sender) (i.e., evidence from prior belief about the sender before receiving the message). For example, FIG. 4 is a flow diagram for dynamically updating whitelists and/or blacklists using these two factors. As illustrated in FIG. 4, as new messages from the same sender are evaluated at 406, the probability that the sender sends spam, or equivalently the probability that the sender is on a blacklist, is updated or adapted at 402 to match the received content at 404. In addition, FIG. 3 illustrates that the probability decision P(spam|history,sender) may be proportionally represented by the two factors P(history|spam) (i.e., accumulated past evidence received from sender) and P(spam|sender) (i.e., initial belief or opinion for sender).

An alternate embodiment for using and updating a soft blacklist may be represented as follows:
P(spam|content,senderhistory)∝(content|spam)P(spam|senderhistory),
   which provides that at time t the probability a message is spam given its content and the sender history is proportional to the evidence from the message content (i.e., the probability of observing the content of a message in the spam category at time t) and to the prior history for the sender of a message (i.e., the probability that a sender of a message sends spam at time less than t). In modifying the prior message information for a sender at t+1, the content of a message at time t becomes part of the sender history for future messages at time greater than t. Accordingly in this alternate embodiment, the message content and prior history (i.e., content, senderhistory) for the sender at time t becomes senderhistory at time t+1. For example, assuming three messages are received in series from the same sender and each has content1, content2, and content3, (at times t, t+1, and t+2) respectively, then:
P(spam|content3, content2, content1 ,senderhistory)
   ∝(content3|spam)P(spam|content2, content1,senderhistory)
   ∝(content3|spam)P(content2|spam)P(spam|content1,senderhistory)
   ∝(content3|spam)P(content2|spam)P(content1|spam)P(spam|senderhistory),
      where initially P(spam|senderhistory) is the “prior” for the sender before receiving any content, and after receiving content1 at t, P(spam|content1,senderhistory) effectively becomes the updated “prior” for the sender at t+1, and so on at t+2.

C.3 Combining History Information and User Feedback

In a third embodiment, the history processor 112 includes a hybrid whitelist/blacklist mechanism that combines history information and user feedback. That is, supplemental to the prior two embodiments, when a user is able to provide feedback, the profile P(content|spam) of the user may change. This occurs when a decision about a borderline spam message is misjudged (for example, not to be spam), which may result because a new vocabulary was introduced in the message. If the user of the system 100 provides user feedback that overrides an automated decision by ruling that a message is actually spam (when the system determines otherwise), then the profile P(content|spam) of the user is updated or adapted to take into account the vocabulary from the message.

More specifically, this embodiment combines the first two embodiments directed at utilizing user feedback and sender history information to provide a third embodiment which allows the system 100 to adapt over time as one or both of user feedback and sender history information prove and disprove “evidence” of spam. In accordance with one aspect of this embodiment, system decisions may be accepted as “feedback” after a trial period (unless rejected within some predetermined period of time) and enforced by adapting history information accessed by the class decision makers as if the user had confirmed classification decisions computed by the categorizer coalescer 110. This allows the history for a sender (i.e., a priori favorable/unfavorable bias for a sender) and/or model parameters or profiles of the categorizer(s) to automatically “drift” or adapt (i) to changing circumstances over time and/or retroactive changes or (ii) to updated categorization decisions already taken to account for the drift.

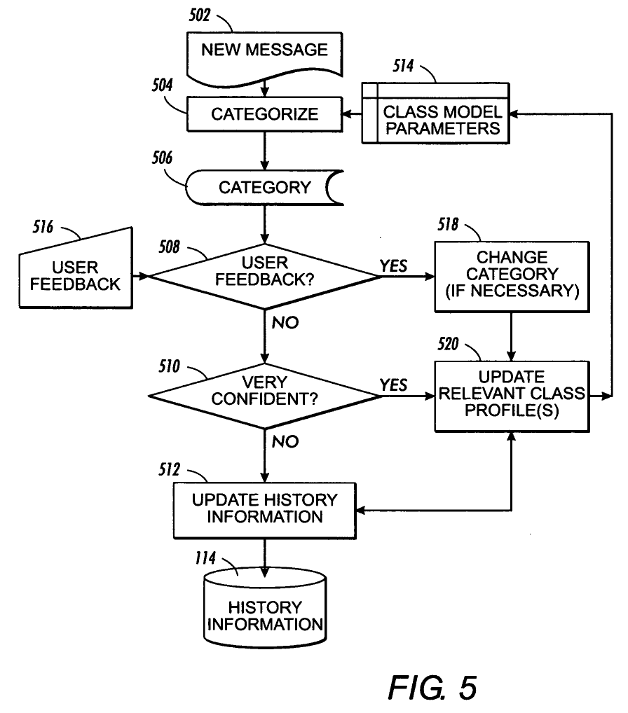

FIG. 5 is a flow diagram for implementing a hybrid whitelist/blacklist mechanism that combines history information and user feedback. Initially (at 502) a new message is categorized (at 504) using class model parameters (at 514) by, for example, one or more class decision makers of categorizer 108 (shown in FIG. 1). Given the category (at 506) output (at 504), a determination is made whether user feedback (at 516) has been provided (at 508). If user feedback is (implicitly or explicitly) provided (at 508), the category (at 506) is altered if necessary (at 518). If no user feedback has been provided (at 508), a determination is made (at 510) as to whether the categorization decision taken (at 504) was made with a high degree of confidence.

Continuing with the flow diagram shown in FIG. 5, if either user feedback (at 516) has been provided (at 508) or the categorization decision was made (at 504) with a high degree of confidence, relevant class profiles used when making the categorization decision (at 504) are updated (at 520) by altering the class model parameters (at 514). In addition to updating the relevant class profiles (at 520), history information 114 is updated (at 512) to account for the attributes in the newly categorized message (at 504). In the event no user feedback is given (at 508) or there is a low level of confidence in the categorization decision (at 510), then history information 114 is updated (at 512), and, possibly, relevant class profiles (at 520) are also updated by altering the class model parameters (at 514) depending on different factors, such as, whether the absence of user feedback is an implied assent to the categorization decision.

More generally, the flow diagram in FIG. 5 illustrates one embodiment when given either user feedback or a high confidence level in a categorization decision taken concerning a message, prior decisions for messages that were taken with little confidence (i.e., are borderline decisions) may be reevaluated to account for the user feedback and/or decisions taken with a large degree of confidence as new messages are evaluated. Advantageously, prior borderline decisions of documents (e.g., that exists in a database or in a mail file) may thus be reevaluated (i.e., reprocessed as a new message at 502) to reflect a changed decision (i.e., spam, not spam) or a high confidence level (borderline, not borderline).

D. Alternate Embodiments

This section describes alternate embodiments of the system 100 shown in FIG. 1. In a first alternate embodiment, the system 100 is made up of a single decision maker or categorizer 120, as identified in FIG. 1 eliminating the need for the categorizer coalescer 110 and the output of more than one class decision.

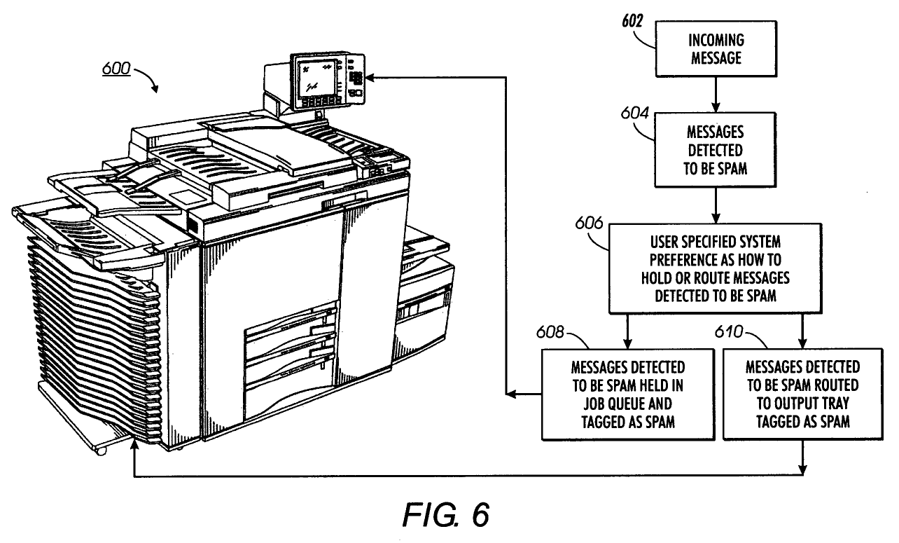

A second alternate embodiment, shown in FIG. 6, involves embodying the system 100 shown in FIG. 1 in a multifunctional device 600 (e.g., a device that scans, prints, faxes, and/or emails). The multifunctional device 600 in this embodiment would include user settable system preferences (or defaults) that specify how a job detected and/or confirmed to be spam should be routed in the system. In one operational sequence shown in FIG. 6, an incoming message (at 602) is detected by the system 100 shown in FIG. 1 (at 604) to be spam and depending on the settings of the user specified preferences (at 606) is either held in the job queue and tagged as spam (at 608) or routed to an output tray tagged as (i.e., dedicated for the receipt of) spam (at 610).

In a third alternate embodiments, the system 100 shown in FIG. 1 may be capable of identifying other classes of information besides spam, such as information that is confidential, underage (e.g., by, for example, producing a content rating following a content rating scheme), copyright protected, obscene, and/or pornographic in nature. Such information may be determined using sender and/or content information. Further, depending on the class of information, different routing schemes and/or priorities may be associated-with the message once a message class has been determined by the system and/or affirmed with user feedback.

In a fourth alternate embodiment, the system 100 shown in FIG. 1 is adapted to identify and filter spam appearing in response to some user action (i.e., not necessarily initiated from the receipt of a message). For example, advertisements may appear not only in message content received and accessed by a user (e.g., by selecting a URL embedded in an email) but also as a result of direct user actions such as accessing a web page in a browser. Accordingly, the system 100 may be adapted to filter spam received through direct user action. Thus, HTTP message data as identified in FIG. 1 may originate directly from an input source that is a web browser. Further, such message data may contain images or image sequences (e.g., movies) as set forth above which embed text therein that is identified using OCR processing. In one specific instance of this embodiment, the system 100 operates (without any routing element) with a web browser (e.g., either embedded directly therein or as a plug-in) for blocking web pages (or a limited set, such as, pop-up web pages) that are identified by the system 100 as spam.

E. Miscellaneous

Those skilled in the art will recognize that a general purpose computer may be used for implementing the systems described herein such as the system 100 shown in FIG. 1. Such a general purpose computer would include hardware and software. The hardware would comprise, for example, a processor (i.e., CPU), memory (ROM, RAM, etc.), persistent storage (e.g., CD-ROM, hard drive, floppy drive, tape drive, etc.), user I/O, and network I/O. The user I/O can include a camera, a microphone, speakers, a keyboard, a pointing device (e.g., pointing stick, mouse, etc.), and the display. The network I/O may for example be coupled to a network such as the Internet. The software of the general purpose computer would include an operating system.

Further, those skilled in the art will recognize that the forgoing embodiments may be implemented as a machine (or system), process (or method), or article of manufacture by using standard programming and/or engineering techniques to produce programming software, firmware, hardware, or any combination thereof. It will be appreciated by those skilled in the art that the flow diagrams described in the specification are meant to provide an understanding of different possible embodiments. As such, alternative ordering of the steps, performing one or more steps in parallel, and/or performing additional or fewer steps may be done in alternative embodiments.

Any resulting program(s), having computer-readable program code, may be embodied within one or more computer-usable media such as memory devices or transmitting devices, thereby making a computer program product or article of manufacture according to the embodiment described herein. As such, the terms “article of manufacture” and “computer program product” as used herein are intended to encompass a computer program existent (permanently, temporarily, or transitorily) on any computer-usable medium such as on any memory device or in any transmitting device.

Executing program code directly from one medium, storing program code onto a medium, copying the code from one medium to another medium, transmitting the code using a transmitting device, or other equivalent acts may involve the use of a memory or transmitting device which only embodies program code transitorily as a preliminary or final step in making, using, or selling the embodiments as set forth in the claims.

Memory devices include, but are not limited to, fixed (hard) disk drives, floppy disks (or diskettes), optical disks, magnetic tape, semiconductor memories such as RAM, ROM, Proms, etc. Transmitting devices include, but are not limited to, the Internet, intranets, electronic bulletin board and message/note exchanges, telephone/modem based network communication, hard-wired/cabled communication network, cellular communication, radio wave communication, satellite communication, and other stationary or mobile network systems/communication links.

A machine embodying the embodiments may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the disclosure as set forth in the claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A system for filtering electronic content for identifying spam in message data, comprising:
a content extractor for identifying and selecting message content in the message data;
a content analyzer having a plurality of information type gatherers for assimilating and outputting different message attributes relating to the message content associated with an information type;
a categorizer having a plurality of decision makers for receiving as input the message attributes and prior history information and providing as output a message class for classifying the message data;
a history processor receiving as input (i) the class decision, (ii) the message class for each of the plurality of decision makers, and (iii) prior history information, for (a) recording the message attributes and the class decision as part of the prior history information and/or (b) modifying the prior history information to reflect changes to fixed data or probability data;
a categorizer coalescer for assessing the message class output by the set of decision makers together with optional user input for producing a class decision identifying whether the message data is spam.

2. The system according to claim 1, wherein the fixed data is a whitelist or a blacklist.

3. The system according to claim 2, wherein the history processor adaptively maintains the contents of the whitelist or the blacklist.

4. The system according to claim 3, wherein the history processor adaptively maintains the whitelist or the blacklist with implicit user feedback that accepts the class decision if it is not changed after a predetermined period of time.

5. The system according to claim 3, wherein the history processor adaptively maintains the whitelist or the blacklist taking into account a favorable bias if a sender has sent a plurality of prior messages containing message data that received favorable class decisions with a high confidence level.

6. The system according to claim 3, wherein the history processor adaptively maintains the whitelist or the blacklist by taking into account a unfavorable bias if a sender has sent a plurality of prior messages containing message data that received unfavorable class decisions with a high confidence level.

7. The system according to claim 1, wherein the probability data changes with time as probabilities associated with a set of sender data or sender message content changes.

8. The system according to claim 7, wherein the probability data is computed based on: (1) evidence from content of the message data received from a sender; (2) accumulated evidence from previous content of message data received from the sender; and (3) initial opinion or bias on the sender, before any content is received.

9. The system according to claim 1, further comprising an input source for receiving the message data including one or more of email, facsimile, HTTP, audio, and video.

10. The system according to claim 1, wherein the content extractor further comprises an OCR engine for identifying textual information in image message data.

11. The system according to claim 10, wherein the content extractor further comprises a voice-to-text converter for converting audio message data to text.

12. The system according to claim 1, wherein the class decision includes routing information.

13. The system according to claim 12, wherein the categorizer coalescer routes the message data according to the routing information.

14. The system according to claim 1, wherein at least one history processor dynamically updates whitelist or blacklist information.

15. The system according to claim 1, wherein at least one history processor retroactively changes class decisions recorded in history information to reflect changes to prior history information.

16. The system according to claim 1, wherein the history processor receives as input the message attributes for the plurality of information types.

17. A system for filtering electronic content for identifying spam in message data, comprising:
a content extractor for identifying and selecting message content in the message data;
a content analyzer having a plurality of information type gatherers for assimilating and outputting different message attributes relating to the message content associated with an information type;
a history processor receiving as input (i) the class decision, (ii) the message class for each of the plurality of decision makers, and (iii) prior history information, for (a) recording the message attributes and the class decision as part of the prior history information or (b) modifying the prior history information to reflect changes to fixed data or probability data;
a categorizer for receiving as input the message attributes and the prior history information and providing as output a message class for classifying the message data.

18. A multifunctional device for processing a job request, comprising:
a memory for storing routing preferences when message data of the job request is classified as spam;
a content extractor for identifying and selecting message content in the message data;
a content analyzer having a plurality of information type gatherers for assimilating and outputting different message attributes relating to the message content associated with an information type;
a history processor receiving as input (i) the class decision, (ii) the message class for each of the plurality of decision makers, and (iii) prior history information, for (a) recording the message attributes and the class decision as part of the prior history information and/or (b) modifying the prior history information to reflect changes to fixed data or probability data;
a categorizer for receiving as input the message attributes and the prior history information and determining a message class for classifying the message data; the categorizer processing the job request according to the routing preferences set forth in the memory and the message class.

19. The multifunctional device according to claim 18, wherein the routing preferences specify that the job request be held in a job queue and identified as spam when the message class classifies the message data as spam.

20. The multifunctional device according to claim 18, wherein the routing preferences specify that the job request to be printed and routed to an output tray reserved for spam when the message class classifies the message data as spam.

21. The multifunctional device according to claim 18, wherein the message data of the job request is facsimile message data, and the content extractor performs OCR to extract text from the message data.
